(19) United States
(12) Patent Application Publication
(10) Pub. No.: US 2009/0079199 A1
(43) Pub. Date: Mar. 26, 2009

(54) ELECTRIC GENERATOR OPERATED BY RECIPROCATING WELLBORE PUMP AND MONITORING SYSTEM USED THEREWITH

(76) Inventor: Paulo S. Tubel, The Woodlands, TX (US)

Correspondence Address: RICHARD A. FAGIN, P.O. BOX 1247, RICHMOND, TX, 77406-1247, US

(21) Appl. No.: 11/860,561

(22) Filed: Sep. 25, 2007

(51) Int. Cl. F01B 23/10; E21B 21/08; H04H 20/84

(52) U.S. Cl. 290/1 A; 166/65.1; 367/82

(57) ABSTRACT

An electrical system for use with a sucker rod pump includes an electric generator configured to be operated by motion of a sucker rod string. The rod string is configured to transfer motive power to the sucker rod pump disposed in a wellbore. The generator is disposed in the wellbore. The system includes at least one electrically powered device electrically coupled to the generator and disposed in the wellbore.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of reciprocating (walking beam) type wellbore fluid pumps. More specifically, the invention relates to electric generators and sensing systems usable therewith that are operated by such pumps.

2. Background Art

Wellbore fluid pumps include reciprocating (“walking beam” or “sucker rod”) pumps. Such pumps are operated by a prime mover, such as an electric motor or natural gas powered engine disposed at the Earth's surface. The prime mover operates a crankshaft coupled to a reciprocating beam. The beam is coupled to an assembly of pumping rods (“rod string”) extended into a wellbore drilled into the Earth's subsurface. A reciprocating pump is coupled to the lower end of the rod string and is anchored at a selected depth in the wellbore. As the walking beam reciprocates, it moves the rod string up and down, causing the movable elements of the pump in the wellbore to move correspondingly. Motion of the pump lifts fluid in the wellbore through a production tubing string to the Earth's surface. Examples of such pumps are described in U.S. Pat. No. 4,681,515 issued to Allen, U.S. Pat. No. 4,788,873 issued to Laney and U.S. Pat. No. 5,204,595 issued to Opal et al.

An issue of concern to operators of such wellbore pumps is if the rate at which the pump lifts fluid to the surface exceeds the flow capacity of the Earth formations outside the wellbore. In such cases, the pump may be operated without sufficient fluid to keep it fully submerged (called “pump off”). Pump of can cause extensive damage to the pump, requiring its removal from the wellbore for repair or replacement. Wellbore pump operators therefore go to considerable effort to operate reciprocating pumps to avoid pump off.

It is known in the art to provide sensing devices in a wellbore and to communicate signals from such sensors to the Earth's surface without hard wired connection. One such system is described in U.S. Pat. No. 6,899,178 issued to Tubel. A system disclosed in the Tubel '178 patent includes a sensor disposed near the lower end of a tubing string, and a wireless transmitter, such as an acoustic transmitter, in signal communication with the sensor. Signals representative of the sensor measurements are transmitted along the tubing string at selected times and are detected and decoded at the Earth's surface for concurrent or later use. The system disclosed in the Tubel '178 patent requires a source of electric power. Typically batteries are used for such electric power. Of course, batteries have a limited lifetime, and require that the system is periodically removed from the wellbore for battery replacement. Such removal requires removal of both the rod string and the tubing, making such battery replacement operation difficult and expensive.

It is desirable to have a source of electric power in a wellbore such that a system such as described in the Tubel '178 patent may be used with a reciprocating pump to monitor fluid level in a wellbore and to maintain battery life so that frequent replacement of batteries is not required.

### SUMMARY OF THE INVENTION

An electrical system for use with a sucker rod pump according to one aspect of the invention includes an electric generator configured to be operated by motion of a sucker rod string. The rod string is configured to transfer motive power to the sucker rod pump disposed in a wellbore. The generator is disposed in the wellbore. The system includes at least one electrically powered device electrically coupled to the generator and disposed in the wellbore.

A method for operating an electrical device in a wellbore according to another aspect of the invention includes moving a sucker rod string along the interior of the wellbore to operate a sucker rod pump. Motion of the rod string is coupled to an electric generator disposed in the wellbore. Electrical power from the generator is used to at least partially power the electrical device in the wellbore.

Other aspects and advantages of the invention will be apparent from the following description and the appended claims.

### BRIEF DESCRIPTION OF THE DRAWINGS

FIG. 1 shows a reciprocating wellbore pump having an electric generator coupled thereto.

FIG. 2 shows the electric generator of FIG. 1 in more detail and a wellbore wireless sensor system that may be used with the generator.

### DETAILED DESCRIPTION

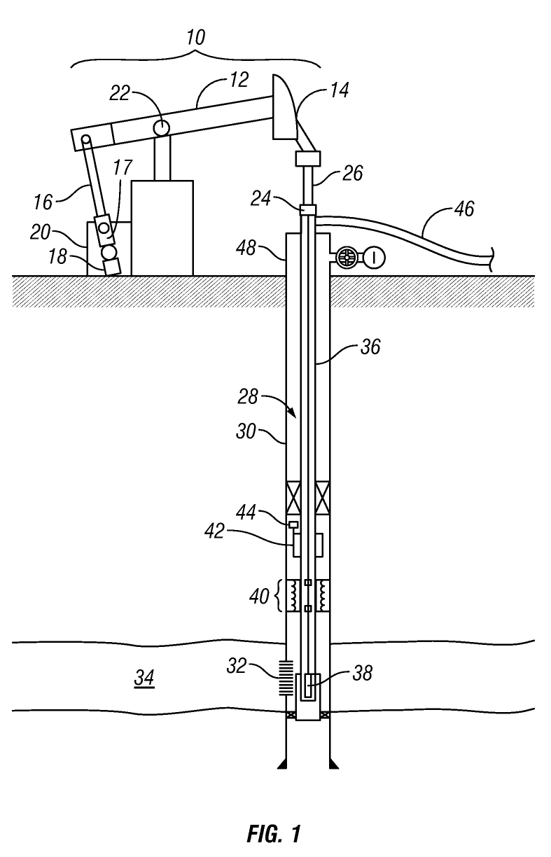

A reciprocating (“walking beam” or “sucker rod”) pump system including a sensing system and one example of an electric power generator is shown schematically in FIG. 1. The beam pump system is shown generally at 10 and includes a reciprocating or walking beam mounted by a bearing 22 on a frame 20 which includes a prime mover such as an electric motor or a natural gas powered engine. The prime mover 20 rotates a crank 17 coupled to one end of the walking beam 12 by a connecting rod 16. Typically the crank 17 will include a counterweight 18 disposed opposite the connection to the connecting rod 16. The counterweight 18 typically weighs the lever arm equivalent of the weight of a rod string 26 disposed in a wellbore 28 plus one half the weight of a column of fluid from the depth of a pump 38 in the wellbore 28 to the Earth's surface. Such counterweight, as is known in the at, provides that the overall work performed by the pump system 10 is substantially equalized over the entire range of motion of the walking beam 12.

The wellbore 28 typically includes a pipe or casing 30 disposed to the bottom of the wellbore 28 and retained therein by cement. The casing 30 typically includes perforations 32 at selected depths corresponding to the depth outside the casing 30 of a productive formation 34 such as may contain oil and/or gas therein. Fluid enters the casing 30 through the perforations 32. A production tubing 36 extends from a well head 48 at the Earth's surface to a selected depth in the wellbore 28. A reciprocating pump 38 is connected to the lower end of the tubing 36. The pump 38 is operated by the rod string 26.

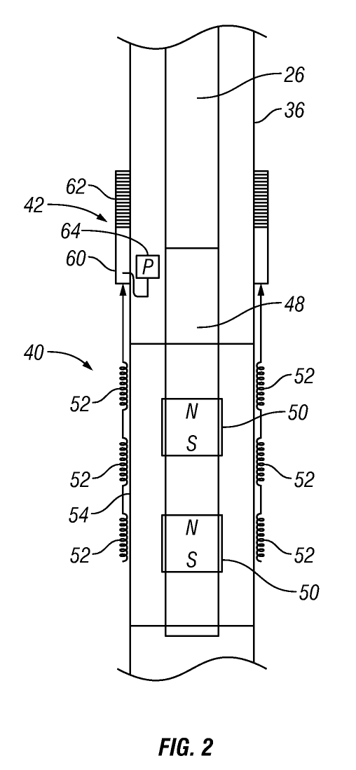

In the example shown in FIG. 1, an electric generator 40 can be disposed in a selected part of the tubing string 36. Electric power produced by the generator 40 can be used to operate a wireless data transmitter 42. The wireless data transmitter 42 is typically coupled to the tubing string 36 and includes devices (not shown in FIG. 1) that can convey data signals along the tubing string 36 corresponding to measurements made by one or more sensors, an example of which is shown schematically at 44. The generator 40 will be explained in more detail below with reference to FIG. 2.

Referring to FIG. 2, the generator 40 may include a non-magnetic, electrically non-conductive tubing joint 54 that may be coupled within the production tubing 36. The joint 54 may be made from fiber reinforced plastic or similar material having the foregoing magnetic and electrical properties. See, for example, U.S. Pat. No. 6,620,475 issued to Reynolds et al. for a description of such fiber reinforced plastic tubing materials. The rod string 26 may include one or more joints therein made from non-magnetic material, such as monel, stainless steel or an alloy sold under the trademark INCONEL, which is a registered trademark of Huntington Alloys Corporation, Huntington, W. Va. One or more permanent magnets 50 may be disposed on the non-magnetic rod string joint 50. As the rod string 26 is reciprocated by operation of the pump system (10 in FIG. 1) the magnets 50 will move correspondingly. One or more wire coils 52 may be wound outside the tubing joint 54. As the magnets 50 are moved inside the non-magnetic tubing joint 54, electric current is induced in the coils 52.

The coils 52 are electrically connected to circuitry 60 forming part of the data telemetry system 42. Such circuits 60 may include (none of which is shown separately) power conditioners to convert the current induced in the coils 52 to direct current and energy storage devices such as a Farad size capacitors or rechargeable batteries. The circuits include devices to actuate an acoustic transmitter 62. The transmitter is actuated to send signals along the tubing string 36 corresponding to signals from one or more sensors 64 in signal communication with the circuits. In the present example, the sensor 64 may be a pressure sensor. A pressure measured by the sensor 64 will correspond to the height of the liquid column in the wellbore (28 in FIG. 1). If the pressure drops to a level indicating an unsafe liquid level in the wellbore, the wellbore operator may be advised of this fact by monitoring the pressure measurements transmitted along the tubing string 36 by the telemetry system 42.

Because the generator produces electric power whenever the pump system (10 in FIG. 1) causes the rod string 26 to move, the circuits 60 may remain energized substantially continuously without the need to remove them to replace batteries, as has proven necessary using wireless telemetry systems known in the art prior to the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An electrical system for use with a sucker rod pump, comprising:
an electric generator configured to be operated by motion of a sucker rod string, the rod string configured to transfer motive power to the sucker rod pump disposed in a wellbore, the generator disposed in the wellbore; and
at least one electrically powered device electrically coupled to the generator and disposed in the wellbore.

2. The system of claim 1 wherein the generator comprises at least one wire coil wound on an electrically non-conductive, non-magnetic tube coupled within a tubing string disposed in the wellbore.

3. The system of claim 2 wherein the tub comprises fiber reinforced plastic.

4. The system of claim 1 wherein the at least one electrically powered device comprises a data telemetry transmitter functionally coupled to a tubing string disposed in the wellbore.

5. The system of claim 4 wherein the telemetry transmitter comprises an acoustic transmitted operatively coupled to the tubing string.

6. The system of claim 4 further comprising at least one sensor in signal communication with the telemetry transmitter.

7. The system of claim 6 wherein the at least one sensor comprises a pressure sensor configured to measure fluid pressure in the wellbore proximate the sucker rod pump.

8. The system of claim 1 wherein the electrical generator comprises at least one permanent magnet coupled to the rod string, whereby motion of the rod string causes corresponding motion of the at least one magnet.

9. The system of claim 8 wherein a joint of the rod string proximate the at least one magnet comprises a non-magnetic metal.

10. A method for operating an electrical device in a wellbore, comprising:
moving a sucker rod string along the interior of the wellbore to operate a sucker rod pump;
coupling motion of the rod string to an electric generator disposed in the wellbore; and
using electrical power from the generator to at least partially power the electrical device in the wellbore.

11. The method of claim 10 further comprising measuring at least one physical parameter proximate the pump, and casing the electrical device to transmit a signal to the Earth's surface corresponding to the value of the measured parameter.

12. The method of claim 10 wherein the at least one physical parameter comprises fluid pressure in the wellbore proximate the pump.

13. The method of claim 10 wherein the transmitting comprises acoustically actuating a tubing string in a wellbore.

14. The method of claim 10 wherein the coupling comprises moving at least one permanent magnet correspondingly with motion of the rod string.

15. The method of claim 14 wherein the at least one magnet is moved inside at least one wire coil disposed about a tubing string disposed in the wellbore.

16. The method of claim 15 wherein a joint of the tubing string upon which the at least one coil is disposed comprises an electrically conductive, non magnetic material.

17. The method of claim 16 wherein the material comprises fiber reinforced plastic.
